(19) United States
(12) Patent Application Publication
(10) Pub. No.: US 2026/0364917 A1
(43) Pub. Date: Nov. 19, 2026

(54) MULTILAYERED COMPOSITE SHEET FOR A VEHICLE ROOF AND METHOD OF MANUFACTURING THEREOF

(71) Applicant: Transtex Composites LLC, Harmony, PA (US)

(72) Inventors: Michael Mantia, Sarver, PA (US); Jeff Fowler, Butler, PA (US)

(73) Assignee: Transtex Composites LLC, Harmony, PA (US)

(21) Appl. No.: 19/673,273

(22) Filed: May 11, 2026

Related U.S. Application Data
(60) Provisional application No. 63/804,812, filed on May 13, 2025.

(51) Int. Cl. B32B 5/26; B32B 5/02; B32B 7/02; B32B 7/03; B32B 7/12; B32B 27/08; B32B 27/12; B32B 27/30; B32B 27/32; B32B 27/40; B60R 13/01

(52) U.S. Cl. CPC B32B 5/26; B32B 5/02; B32B 5/022; B32B 7/02; B32B 7/03; B32B 7/12; B32B 27/08; B32B 27/12; B32B 27/304; B32B 27/32; B32B 27/40; B32B 2262/0284; B32B 2262/101; B32B 2307/712; B32B 2307/7376; B32B 2605/00; B60R 13/01

(57) ABSTRACT

A multilayered composite sheet is adapted for vehicle roofs and other similar application. The multilayered composite sheet is made of a first composite layer adapted for resisting weather; a core layer made of, or comprising, a Continuous Fiberglass Reinforced Polypropylene (CFRPP) comprising multiple glass orientation layers; and a second composite layer. The layers are e.g., laminated, bond or thermally bonded with one another. At least one of the composite layers comprises a plurality of layers made of, or comprising, at least two different materials.

### CROSS-REFERENCE TO RELATED APPLICATION

This application relates to and is a non-provisional application claiming priority under 35 U.S.C. §119(e) and 37 C.F.R. § 1.78(a) for a priority claim to an earlier-filed provisional application Ser. No. 63/804,812, filed May 13, 2025, entitled MULTILAYERED COMPOSITE SHEET FOR A VEHICLE ROOF AND METHOD OF MANUFACTURING THEREOF, the specification of which is hereby incorporated herein by reference in its entirety.

### BACKGROUND

### Field

The present invention relates generally to polymeric materials, and more specifically to a multilayered fiberglass-reinforced composite sheet with enhanced structural and weather-resistant properties suitable for use on recreational vehicles and other roofing applications.

### Related Prior Art

Continuous fiberglass sheets are widely used in various industries due to their lightweight, durability, and cost-effectiveness. However, conventional continuous fiberglass sheets often lack specific properties such as high impact resistance, UV protection, adhesion strength, or weather durability.

There is therefore a need for a cost-effective, scalable composite sheet that overcomes these shortcomings. There is also a need for a scalable composite sheet that can be customized with tailored properties for specific applications such as vehicle roofs.

### SUMMARY

There is herein described a multilayered composite sheet comprising two or more distinct polymer layers extruded or laminated together. Each layer serves a functional purpose, such as providing structural strength, weather resistance, adhesive bonding strength, or UV protection. The layers comprise a combination of materials that may include continuous fiberglass-reinforced polypropylene (CFRPP), polyethylene terephthalate (PET), polyethylene terephthalate (PET) with a surface treatment to promote polyurethane (PU) bonding, polyvinyl chloride (PVC), or TPO (thermoplastic olefin), or other suitable thermoplastics.

The multilayered composite sheet may also include additives such as UV stabilizers, bonding agents, flame retardants, or colorants. The composition of the layers, the combination of materials used for the layers, and the order of layering the materials of the multilayered composite sheet are engineered to meet specific performance criteria.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive, and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a cross-section schematic of a multilayered composite sheet in accordance with an embodiment; and

FIGS. 2 and FIG. 3 are schematics of sheets of Continuous Fiberglass Reinforced Polypropylene (CFRPP) comprising a plurality of layers having different fiber orientations.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term "or" should generally be understood to mean "and/or" and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about”, “approximately”, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as”, or the like) provided herein, is intended merely to better illuminate the exemplary realizations and does not pose a limitation on the scope of the realizations. No language in the specification should be construed as indicating any unclaimed element as essential to the practice of the realizations. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as "first", "second", "top", "bottom", "above", "below", and the like, are words of convenience and are not to be construed as limiting terms.

It should further be noted that for purposes of this disclosure, the term "coupled" means the joining of two members directly or indirectly to one another. Such joining may be achieved with the two members, or the two members and any additional intermediate members being integrally formed as a single unitary body with one another or with the two members or the two members and any additional intermediate members being attached to one another.

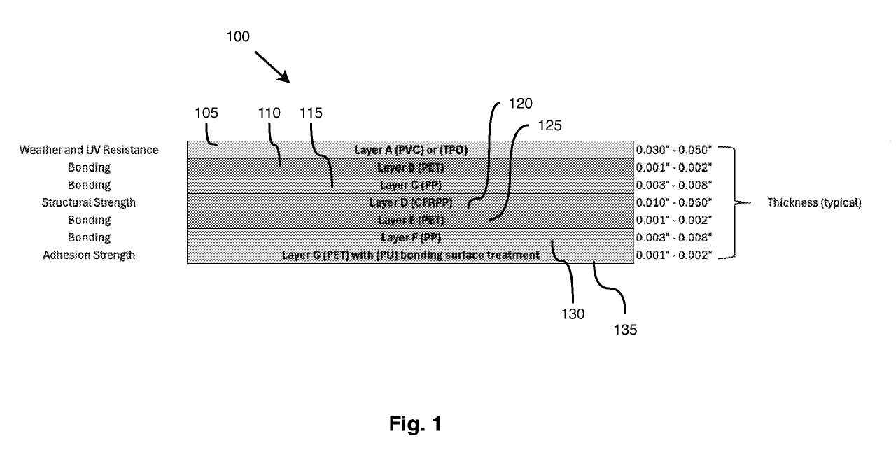

Referring now to the drawings, and more particularly to FIG. 1, the multilayered composite sheet 100 is suitable for a variety of roof membrane uses, including, without limitation, Recreational Vehicles (RVs), storage containers, cargo compartments of vehicles and cargo trailers, and temporary or semi-permanent buildings such as residential housing units.

According to a first embodiment, the multilayered composite sheet 100 of the present disclosure comprises a first composite layer assembly comprising:
Layer A 105 (top layer or weather-sustaining layer). The layer A 105 is made of, or comprises, a Polyvinyl Chloride (PVC) membrane. The layer A 105 provides a degree of surface toughness and weather resistance.
According to another embodiment, the layer A 105 is made of, or comprises, a thermoplastic Olefin (TPO) membrane, with the alternative layer A providing about the same characteristics.
Layer B 110 (intermediate layer). The layer B 110 is made of, or comprises, Polyethylene terephthalate (PET) nonwoven fabric. The layer B 110 provides mechanical bonding.
Layer C 115 (intermediate layer). The layer C 115 is made of, or comprises, Polypropylene (PP). The layer C 115 provides enhanced polymer bonding.

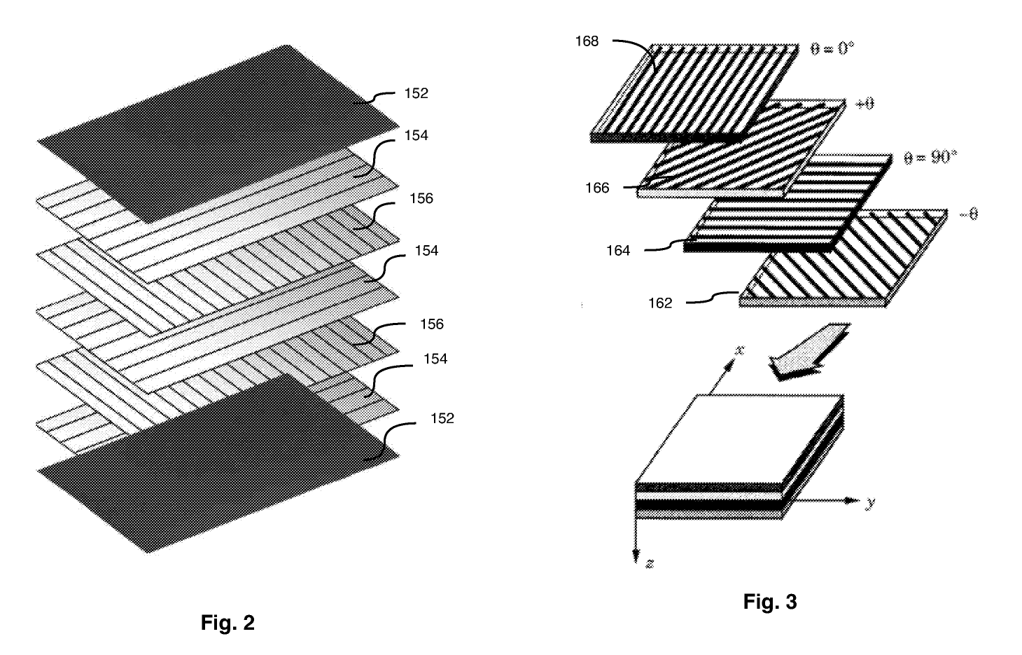

The multilayered composite sheet 100 further comprises a core layer comprising at least:
Layer D 120 (core layer). The layer D 120 is made of, or comprises, a Continuous Fiberglass Reinforced Polypropylene (CFRPP) comprising multiple glass orientation layers (see, e.g., in FIGS. 2 and FIG. 3 for illustration). The layer D 120 provides structural strength, particularly shear resistance in many orientations, to the multilayered composite sheet 100.

For illustration, FIG. 2 depicts a CFRPP having two external layers 152, 152 with five intermediary layers with their orientation alternating orthogonally between layer. In FIG. 2, the layers 154 are oriented in one direction and layers 156 are oriented orthogonally relative to the layers 154. FIG. 3 illustrates an embodiment wherein the orientation of the fibers are rotated of an angle of e.g., 45 degrees, relative to the preceding layer. For example, layer 162 has a first orientation of fibers. Layer 164 has its fibers oriented at 45 degrees compared to the fibers of layer 162. Layer 166 has its fibers oriented at 45 degrees compared to the fibers of layer 164. And layer 168 has its fibers oriented at 45 degrees compared to the fibers of layer 166. In the example, shift and shift direction of the orientation of the fibers are constant from one layer to the next.

According to embodiments, the CFRPP comprises at least two layers with their respective fibers oriented orthogonally from each other. According to embodiment, the CFRPP comprises a number of at least one layer with the fibers thereof oriented at between 30 degrees and 60 degrees, e.g., 45 degrees, from the orientation of the fibers of another layer of the CFRPP.

Accordingly, the strength of the CFRPP of a multilayered composite sheet 100 is set through at least one of the following strategies: modifying the density of fibers of at least one of the layers composing the CFRPP, modifying the dimension, e.g., average diameter or maximum diameter of at least one of the layers composing the CFRPP, and modifying the number of layers and/or orientation of layers of the CFRPP in a set direction or with small difference of orientation relative to the set direction. Accordingly, strength in a set direction may be modulated through one or more of these strategies.

The multilayered composite sheet 100 further comprises additional layers comprising:
Layer E 125 (intermediate layer). The layer E 125 is made of, or comprises, Polyethylene terephthalate (PET) nonwoven fabric. The layer E 125 provides mechanical bonding.
Layer F 130 (intermediate layer). The layer F 130 is made of, or comprises, Polypropylene (PP). The layer F 130 provides enhanced polymer bonding.
Layer G 135 (bottom layer or interior layer). The layer G 135 is made of, or comprises, Polyethylene terephthalate (PET) with a surface treatment to promote Polyurethane (PU) bonding. The layer G 135 provides surface adhesion.

It is to be noted that the nature and number of layers may vary with embodiments. The multilayer composite sheet 100 generally comprises a core layer 120 made of, or comprises, a Continuous Fiberglass Reinforced Polypropylene (CFRPP) providing non-unidirectional structural strength thereto, combined with, e.g., bonded with or laminated with, other layers adapted to specific purpose such as adapted for weather and UV resistance.

According to an exemplary embodiment, the thicknesses of the layers A to G are as follows:
Layer A 105 has a thickness of between about 0.020 and 0.075 inches, preferably between about 0.025 and 0.065 inches, and more preferably 0.030 and 0.050 inches.
Layer B 110 has a thickness of between about 0.0005 and 0.003 inches, preferably between about 0.0008 and 0.0025 inches, and more preferably 0.001 and 0.002 inches.
Layer C 115 has a thickness of between about 0.002 and 0.015 inches, preferably between about 0.0025 and 0.012 inches, and more preferably 0.003 and 0.008 inches.
Layer D 120 has a thickness of between about 0.005 and 0.075 inches, preferably between about 0.007 and 0.065 inches, and more preferably 0.010 and 0.050 inches.
Layer E 125 has a thickness of between about 0.0005 and 0.003 inches, preferably between about 0.0008 and 0.0025 inches, and more preferably 0.001 and 0.002 inches.
Layer F 130 has a thickness of between about 0.002 and 0.012 inches, preferably between about 0.0025 and 0.010 inches, and more preferably 0.003 and 0.008 inches.
Layer G 135 has a thickness of between about 0.0005 and 0.003 inches, preferably between about 0.0008 and 0.0025 inches, and more preferably 0.001 and 0.002 inches.

In embodiments, the ratio of the thickness of the CFRPP over the whole thickness of the multilayered composite sheet 100 is between 20% and 40%, and preferably between 25% and 33%.

It is worth noting that these thicknesses are exemplary thicknesses for teaching purposes. The thicknesses of one or more layers will vary based on the desired characteristics for the multilayered composite sheet 100, the method of manufacture, and the presence or absence of one or more of the layers listed in the exemplary embodiment of a multilayered composite sheet 100.

According to embodiments, the total thickness of the multilayered composite sheet 100 can range between about 0.040 and 0.122 inches.

Methods of manufacture of the multilayered composite sheet 100 may involve the following methods. The multilayered composite sheet 100 may be manufactured by extrusion. The multilayered composite sheet 100 may be manufactured by lamination. The multilayered composite sheet 100 may be manufactured by hot-melting bonding techniques. When manufactured, each layer and/or layer adjunction is processed at the appropriate temperature, e.g., melting temperature, to ensure optimal adhesion and uniform thickness.

Additive or functional agents may be included in one or more layers for improved characteristics and/or for additional characteristics. Exemplary additive and functional agents comprise UV stabilizers used to protect the layer(s) against degradation from sunlight, bonding agents improving the strength of composite layers, flame retardants, and colorants that may be desirable for meeting specific application needs.

Accordingly, the multilayered composite sheet 100 features a combination of characteristics appropriate for the listed uses.

An exemplary multilayered composite sheet 100 was manufactured by lamination. The multilayered composite sheet 100 is made of a combination of seven layers listed before as layers A to G, and consisting of the following materials: PVC, PET, PP, CFRPP, PET, PP, PU. The multilayered composite sheet 100 manufactured according to that method and these characteristics exhibited an ASTM D3763 puncture resistance of 1534 N - Max Load and 5.09 J - Energy Absorbed at Max Load.,

While preferred embodiments have been described above and illustrated in the accompanying drawings, it will be evident to those skilled in the art that modifications may be made without departing from this disclosure. Such modifications are considered as possible variants comprised in the scope of the disclosure.

1. A multilayered composite sheet comprising:
a first composite layer adapted for resisting weather;
a core layer made of, or comprising, a Continuous Fiberglass Reinforced Polypropylene (CFRPP) comprising multiple glass orientation layers; and
a second composite layer,
wherein at least one of a) the first composite layer and b) the second composite layer comprises a plurality of layers made of, or comprising. at least two different materials, and
wherein the core layer is adjoined on a first face to the first composite layer and on a second face to the second composite layer.

2. The multilayered composite sheet of claim 1, wherein the core layer comprises at least three layers, and wherein at least two of the three layers are perpendicularly oriented.

3. The multilayered composite sheet of claim 1, wherein the core layer comprises at least three layers, and wherein at least two of the layers are parallelly oriented.

4. The multilayered composite sheet of claim 1, wherein the core layer comprises at least three layers, and wherein at least two of the layers have an angle between their orientation of between 30 degrees and 60 degrees.

5. The multilayered composite sheet of claim 1, wherein the first composite layer, the core layer, and the second composite layer are laminated over one another.

6. The multilayered composite sheet of claim 1, comprising at least five layers.

7. The multilayered composite sheet of claim 1, wherein the first layer is made of, or comprises, a Polyvinyl Chloride (PVC) membrane.

8. The multilayered composite sheet of claim 1, wherein the second layer is made of, or comprises, Polyurethane (PU).

99 The multilayered composite sheet of claim 1, further comprising a first intermediary layer between the core layer and at least one of the first and second layers, wherein the first intermediary layer is made of, or comprises, Polyethylene terephthalate (PET) nonwoven fabric.

10. The multilayered composite sheet of claim 1, further comprising a second intermediary layer between the core layer and at least one of the first and second layers, wherein the second intermediary layer is made of, or comprises, Polypropylene (PP).

11. The multilayered composite sheet of claim 1, further comprising a bonding agent disposed between two of the layers, the bonding agent bonding the two layers to one another.

12. The multilayered composite sheet of claim 1, having a thickness of between 0.040 of an inch and 0.122 of an inch.

13. The multilayered composite sheet of claim 1, wherein the core layer comprises at least 20% of the thickness of the multilayered composite sheet.

14. The multilayered composite sheet of claim 1, wherein the core layer comprises less than 40% of the thickness of the multilayered composite sheet.

15. The multilayered composite sheet of claim 1, further comprising a first set of bonding layers between the core layer and one of the first and second layers, the first set of bonding layers comprising a first bonding layer made of, or comprising, a Polyethylene terephthalate (PET) nonwoven fabric and a second bonding layer made of, or comprising, Polypropylene (PP).

16. The multilayered composite sheet of claim 15, wherein the first layer is for facing weather conditions, wherein the first bonding layer is closer to the first layer than the second bonding layer.

17. The multilayered composite sheet of claim 15, comprising the first set of bonding layers disposed between the first layer and the core layer, and a second set of bonding layers disposed between the core layer and the second layer.

18. The multilayered composite sheet of claim 17, wherein the first set of bonding layers and the second set of bonding layers are identical.

19. The multilayered composite sheet of claim 1, wherein a UV stabilizer is incorporated or applied to the first layer.

20. A method of manufacturing the multilayered composite sheet of claim 1, comprising:
(a) layering at least two of the layers of the multilayered composite sheet one aver another;
(b) bonding the layered layers through a lamination process or a thermos-bonding process;
(c) repeating step (a) and step (b) until obtaining the multilayered composite sheet.
